(19) United States
(12) Patent Application Publication
(10) Pub. No.: US 2004/0125473 A1
(43) Pub. Date: Jul. 1, 2004

(54) Dual vision side mirror

(76) Inventor: Alfred M. Boccella, Drexel Hill, PA (US)

Correspondence Address: ALFRED M. BOCCELLA, 347 FAIRFAX ROAD, DREXEL HILL, PA, 19026, US

(21) Appl. No.: 10/459,629

(22) Filed: Dec. 10, 2003

Related U.S. Application Data
(60) Provisional application No. 60/388,048, filed on Jun. 12, 2002.

(51) Int. Cl. G02B 5/08

(52) U.S. Cl. 359/866; 359/838

(57) ABSTRACT

An automobile approaching on either side of another automobile, as the approaching car reaches to approximately. The rear tire either side of the car ahead of them, there is created a blind spot in the vision as viewed in the side mirrors. Passing auto believes that the car they are passing can see their turn signals and will proceed to pass and cut in front of them, but in reality the car in front does not see the signal. In front of them, but in reality the car in front does not see the signal. My invention places a prism at 2 to 15 degrees angled in the out side of the rear mirrors on both sides of the car. What the prism does allow the normal image of the regular rear mirror and additional image several feet outside of the view. There for allowing a car to to have complete view of a passing automobile.

### BACKGROUND OF THE INVENTION

This invention is contained in the field of automobile safety. The invention is titled Dual Vision Rear Mirror and is designed to correct the void caused by the “BLIND SPOT”. This invention was first submitted as a provisional in May 28, 2002 confirmation no. 6223 and as a non provisional Jun. 11, 2003 conformation 3064.

### DESCRIPTION OF PREFERRED EMBODIMENTS

The dual vision or side mirror is superior then current or proposed mirror or current invention, which includes the flashing side mirror which does not allow enough adequate reaction time The three mirror windshield rear view mirror does provide a clean enounclear distorted view of blind spot and is driver confusing.

Rear view mirror is far more superior then any current or any other mirror inventions. all the mirrors all pointing in different directions mounted on windshield, The former gives very little cross over protect since no other substitute for the common turn signal installed vehicles. The later invention does not provide use in haulers and other large vehicles. Such as convertibles, u-haul trucks, and limousines who have a small rear mirrors which does Protect blind spot vision properly. The dual vision side mirror can be universally utilized in all vehicles foreign an domestic, and is cost effective as well as full proof for providing protection. The dual vision mirror can detect small children and pedestrians while backing up in driveways, shopping malls, pulling out of a parking space would be unsafe without it. The three way mirror is not protective when it comes to millions of small to large vehicles.

### BRIEF DESCRIPTION OF THE DRAWINGS

FIG. 1 is a front perspective view of the dual vision rear mirror assembly.

FIG. 2 is an overhead view of the dual vision rear view mirror depicting white lines are position of dual mirror.

FIG. 3 is a side view of the dual vision rear mirror.

FIG. 4 is a back view dual vision rear mirror.

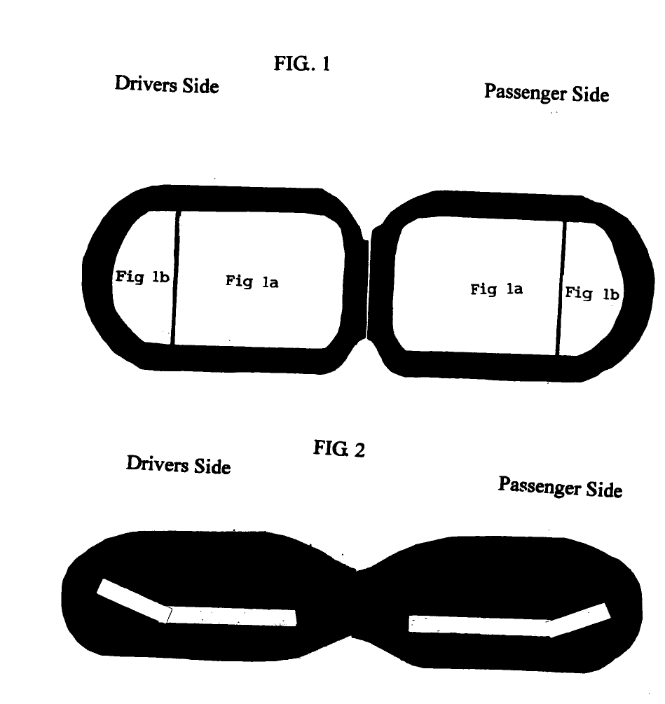

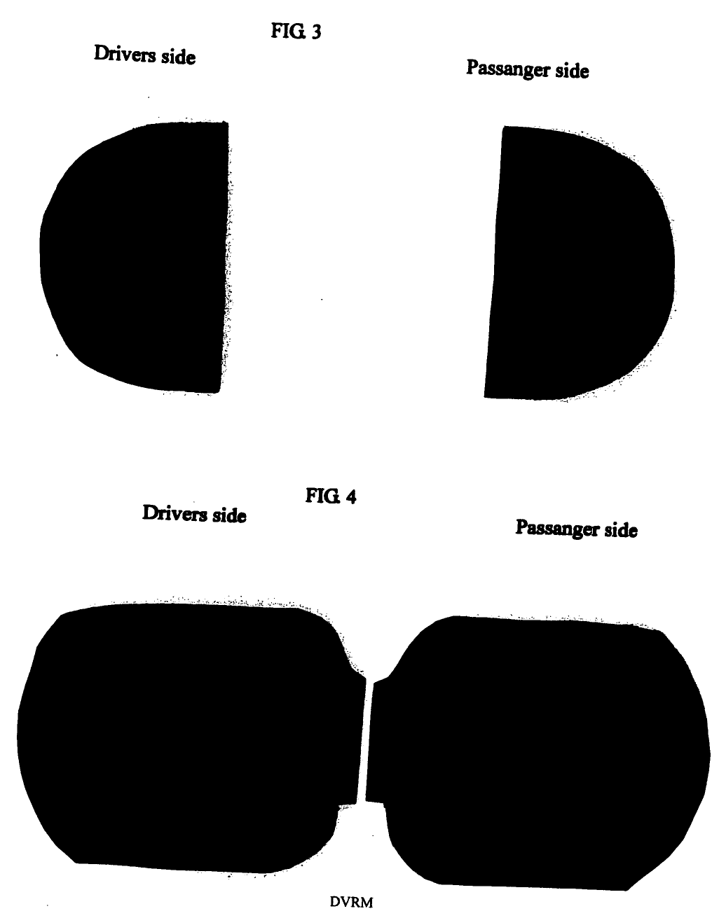

1. Referring to FIG. 1 to 4 it is demonstrated that the assemblyment of the invention of the rear view contains a two dimensional piece of reflective glass containing an average 30% of the outer portion, respectively, angled in an average
10 degrees to provide a clear image of the BLIND SPOT with remaining portion.
70% percent of the straight mirror for normal rear view vision.
Said rear view mirror is mounted on both sides of automobile, trucks and other motor vehicles with angled 30% portion being on outer position of both rear view left and right view mirrors. Although the size and design of the side rear mirrors will vary slightly from each car, truck, or other motor vehicles manufacturers. The structural design of the dual vision side mirrors will remain basically the same, said design consisting of a 2 part mirror image. FIG. 1a. approximately 70% will be the standard straight rear view portion, While FIG. 1b. will be 30% mirror angled inward or depicted in FIG.c..average size of total mirror will be 7″ or 17.5 cm and 4″ or 10 cm in height.
